(19) United States
(12) Patent Application Publication
(10) Pub. No.: US 2017/0092984 A1
(43) Pub. Date: Mar. 30, 2017

(54) POLYMER ELECTROLYTE WITH WELL-DEFINED CUBIC SYMMETRY AND PREPARATION METHOD THEREOF

(71) Applicant: Postech Academy-Industry Foundation, Pohang-si (KR)

(72) Inventors: Moon Jeong Park, Pohang-si (KR); Onnuri Kim, Pohang-si (KR)

(73) Assignee: Postech Academy-Industry Foundation, Pohang-si (KR)

(21) Appl. No.: 15/275,310

(22) Filed: Sep. 23, 2016

(30) Foreign Application Priority Data
Sep. 25, 2015 (KR) 10-2015-0136732
Nov. 9, 2015 (KR) 10-2015-0156437

(51) Int. Cl. H01M 10/0565; C08F 297/04

(52) U.S. Cl. CPC H01M 10/0565; C08F 297/046; H01M 2300/0082

(57) ABSTRACT

The present invention relates to a polymer electrolyte with a well-defined cubic symmetry and a preparation method thereof, and more particularly, to a polymer electrolyte with a well-defined cubic symmetry, which exhibits excellent ionic conductivity, and a preparation method thereof.

### BACKGROUND OF THE INVENTION

Field of the Invention

The present invention relates to a polymer electrolyte with a well-defined cubic symmetry and a preparation method thereof, and more particularly, to a polymer electrolyte with a well-defined cubic symmetry, which exhibits excellent ionic conductivity, and a preparation method thereof.

Description of the Prior Art

To improve the ionic conductivity of polymer electrolytes, there have been developed methods that either use block copolymers wherein ionic domains and nonionic domains enabling mechanical strength to be maintained are linked by covalent bonds, or use ionic liquids. If block copolymers and ionic liquids are used in combination, fine phase separation can be more easily induced while the ionic liquids will be dissolved into the ionic domains of the block copolymers, and the resulting various nanostructures will exhibit effective ionic conductivity.

Korean Patent No. 145364 discloses methods for improving the ionic conductivity of block copolymers having various nanostructures by use of ionic liquids. The patent issued to the present inventors discloses polymer electrolytes which have hexagonal cylindrical phases, layered phases or gyroid phases, and thus have improved ionic conductivity.

Prior art documents related to the present invention are as follows.

### PRIOR ART DOCUMENTS

### Non-Patent Documents

(Non-patent document 1) Meyer, W. H. Polymer Electrolytes for Lithium-Ion Batteries. Adv. Mater. 1998, 10, 439-448.

(Non-patent document 2) Hickner, M. A.; Ghassemi, H.; Kim, Y. S.; Einsla, B. R.; McGrath, J. E. Alternative Polymer Systems for Proton Exchange Membranes. Chem. Rev. 2004, 104, 4587-4612.

(Non-patent document 3) Yang, H.; Yu, C.; Song, Q.; Xia, Y.; Li, F.; Chen, Z.; Li, X.; Yi, T.; Huang, C. High-Temperature and Long-Term Stable Solid-State Electrolyte for Dye-Sensitized Solar Cells by Self-assembly. Chem. Mater. 2006, 18, 5173-5177.

(Non-patent document 4) Bouchet, R.; Maria, S.; Meziane, R.; Aboulaich, A.; Lienafa, L.; Bonnet, J-P.; Phan, T. N. T.; Bertin, D.; Gigmes, D.; Devaux, D.; Denoyel, R.; Armand, M. Single-Ion BAB Triblock Copolymers as Highly Efficient Electrolytes for Lithium-Metal Batteries. Nat. Mater. 2013, 12, 452-457.

(Non-patent document 5) Devanathan, R. Recent Developments in Proton Exchange Membranes for Fuel Cells. Energy Environ. Sci. 2008, 1, 101-119.

(Non-patent document 6) Jo, G.; Ahn, H.; Park, M. J. Simple Route for Tuning the Morphology and Conductivity of Polymer Electrolytes: One End Functional Group is Enough. ACS Macro Lett. 2013, 2, 990-995.

(Non-patent document 7) Jangu, C.; Savage, A. M.; Zhang, Z.; Schultz, A. R.; Madsen, L. A.; Beyer, F. A.; Long, T. E. Sulfonimide-Containing Triblock Copolymers for Improved Conductivity and Mechanical Performance. Macromolecules 2015, 48, 4520-4528.

(Non-patent document 8) Ryu, S-W.; Trapa, P. E.; Olugebefola, S. C.; Gonzalez-Leon, J. A.; Sadoway, D. R.; Mayes, A. M. Effect of Counter Ion Placement on Conductivity in Single-Ion Conducting Block Copolymer Electrolytes. J. Electrochem. Soc. 2005, 152, A158-A163.

(Non-patent document 9) Yochelis, A.; Singh, M. B.; Visoly-Fisher, I. Coupling Bulk and Near-Electrode Interfacial Nanostructuring in Ionic Liquids. Chem. Mater. 2015, 27, 4169-4179.

(Non-patent document 10) Lee, M.; Choi, U. H.; Colby, R. H.; Gibson, H. W. Ion Conduction in Imidazolium Acrylate Ionic Liquids and their Polymers. Chem. Mater. 2010, 22, 5814-5833.

(Non-patent document 11) Ohno, H. Electrochemical Aspects of Ionic Liquids (John Wiley & Sons, Inc., Hoboken, N.J., 2005).

(Non-patent document 12) Virgili, J. M.; Nedoma, A. J.; Segalman, R. A.; Balsara, N. P. Ionic Liquid Distribution in Ordered Block Copolymer Solutions. Macromolecules 2010, 43, 3750-3756.

(Non-patent document 13) Suga, T.; Takeuchi, S.; Nishide, H. Morphology-Driven Modulation of Charge Transport in Radical/Ion-Containing, Self-Assembled Block Copolymer Platform. Adv. Mater. 2011, 23, 5545-5549.

(Non-patent document 14) Hoarfrost, M. L.; Segalman, R. A. Conductivity Scaling Relationships for Nanostructured Block Copolymer/Ionic Liquid Membranes. ACS Macro Lett. 2012, 1, 937-943.

(Non-patent document 15) Gwee, L.; Choi, J, -H.; Winey, K. I.; Elabd, Y. A. Block Copolymer/Ionic Liquid Films: The Effect of Ionic Liquid Composition on Morphology and Ion Conduction. Polymer 2010, 51, 5516-5524.

(Non-patent document 16) Hoarfrost, M. L.; Tyagi, M. S.; Segalman, R. A.; Reimer, J. A. Effect of Confinement on Proton Transport Mechanisms in Block Copolymer/Ionic Liquid Membranes. Macromolecules 2012, 45, 3112-3120.

(Non-patent document 17) Hoarfrost, M. L.; Segalman, R. A. Ionic Conductivity of Nanostructured Block Copolymer/Ionic Liquid Membranes. Macromolecules 2011, 44, 5281-5288.

(Non-patent document 18) Park, M. J.; Kim, S. Y. Ion Transport in Sulfonated Polymers. J. Polym. Sci., Part B: Polym. Phys. 2013, 51, 481-493.

(Non-patent document 19) Kim, 0.; Jo, G.; Park, Y.; Kim, S.; Park, M. J. Ion Transport Properties of Self-Assembled Polymer Electrolytes: The Role of Confinement and Interface. J. Phys. Chem. Lett. 2013, 4, 2111-2117.

(Non-patent document 20). Kim, O.; Kim, S. Y.; Ahn, H.; Kim, C. W.; Rhee, Y. M.; Park, M. J. Phase Behavior and Conductivity of Sulfonated Block Copolymers Containing Heterocyclic Diazole-Based Ionic Liquids. Macromolecules, 2012, 45, 8702-8713.

(Non-patent document 21) Kim, S. Y.; Kim, S.; Park, M. J. Enhanced Proton Transport in Nanostructured Block Copolymer Electrolyte/Ionic Liquid Membrane under Water Free Conditions. Nat. Commun. 2010, 1, 88.

(Non-patent document 22) Madhavan, P.; Sougrat, R.; Behzad, A. R.; Peinemann, K.-V.; Nunes, S. P. Ionic Liquids as Self-Assembly Guide for the Formation of Nanostructured Block Copolymer Membranes, J. Membr. Sci. 2015, 492, 568-577.

(Non-patent document 23) Bates, F. S.; Fredrickson, G. H. Block Copolymers-Designer Soft Materials. Phys. Today 1999, 52, 32-38.

(Non-patent document 24) Jannasch, P. Ionic Conductivity in Physical Networks of Polyethylene-Polyether-Polyethylene Triblock Copolymers. Chem. Mater. 2002, 14, 2718-2724.

(Non-patent document 25) Wang, S. W.; Liu, W.; Colby, R. H. Counterion Dynamics in Polyurethane-Carboxylate Ionomers with Ionic Liquid Counterions. Chem. Mater. 2011, 23, 1862-1873.

(Non-patent document 26) Jangu, C.; Wang, J-H. W.; Wang, D.; Fahs, G.; Heflin, J. R.; Moore, R. B.; Colby, R. H.; Long, T. E. Imidazole-Containing Triblock Copolymers with a Synergy of Ether and Imidazolium Sites. J. Mater. Chem. C, 2015, 3, 3891-3901.

(Non-patent document 27) Audus, D. J.; Gopez, J. D.; Krogstad, D. V.; Lynd, N. A.; Kramer, D. J.; Hawker, C. J.; Fredrickson, G. H. Phase Behavior of Electrostatically Complexed Polyelectrolyte Gels Using an Embedded Fluctuation Model. Soft Matter, 2015, 11, 1214-1225.

(Non-patent document 28) Choi, J. H.; Willis, C. L.; Winey, K. I. Structure Property Relationship in Sulfonated Pentablock Copolymers. J. Membr. Sci. 2012, 394-395, 169-174.

(Non-patent document 29) Zhang, H.; Li, L.; Moller, M.; Zhu, X.; Rueda, J. J. H.; Rosenthal, M.; Ivanov, D. A. From Channel-Forming Ionic Liquid Crystals Exhibiting Humidity-Induced Phase Transitions to Nanostructured Ion-Conducting Polymer Membranes. Adv. Mater. 2013, 25, 3543-3548.

(Non-patent document 30) Ichikawa, T.; Yoshio, M.; Hamasaki, A.; Kagimoto, J.; Ohno, H.; Kato, T. 3D Interconnected Ionic Nano-Channels Formed in Polymer Films: Self-Organization and Polymerization of Thermotropic Bicontinuous Cubic Liquid Crystals. J. Am. Chem. Soc. 2011, 133, 2163-2169.

(Non-patent document 31) Hamley, I. W.; Mai, S.-M.; Ryan, A. J.; Fairclough, J. P. A.; Booth, C. Aqueous Mesophases of Block Copolymers of Ethylene Oxide and 1,2-Butylene Oxide. Phys. Chem. Chem. Phys. 2001, 3, 2972-2980.

(Non-patent document 32) Glatter, O.; Kratky, O. Small Angle X-ray Scattering (Academic Press, London, 1982).

(Non-patent document 33) Lodge, T. P.; Pudil, B.; Hanley, K. J. The Full Phase Behavior for Block Copolymers in Solvents of Varying Selectivity. Macromolecules 2002, 35, 4707-4717.

(Non-patent document 34) Stadler, R.; Auschra, C.; Beckmann, J.; Krappe, U.; Voigt-Martin, I.; Leibler, L. Morphology and Thermodynamics of Symmetric Poly(A-block-B-block-C) Triblock Copolymers. Macromolecules 1995, 28, 3080-3097.

(Non-patent document 35) Epps, T. H.; Cochran, E. W.; Bailey, T. S.; Waletzko, R. S.; Hardy, C. M.; Bates, F. S. Network Phases in ABC Triblock Copolymers. Macromolecules 2004, 37, 7085-7088.

(Non-patent document 36) McIntosh, L. D.; Kubo, T.; Lodge, T. P. Morphology, Modulus, and Conductivity of a Triblock Terpolymer/Ionic Liquid Electrolyte Membrane. Macromolecules

(Non-patent document 37) Carman, P. C. Flow of Gases through Porous Media (Butterworths Scientific, London, 1956).

(Non-patent document 38) Chen, L.; Phillip, W. A.; Cussler, E. L.; Hillmyer, M. A. Robust Nanoporous Membranes Templated by a Doubly Reactive Block Copolymer. J. Am. Chem. Soc. 2007, 129, 13786-13787.

(Non-patent document 39) Phillip, W. A.; Amendt, M.; O'Neill, B.; Chen, L.; Hillmyer, M. A.; Cussler, E. L. Diffusion and Flow across Nanoporous Polydicyclopentadiene-Based Membranes. ACS Appl. Mater. Interfaces, 2009, 1 (2), 472-480.

### SUMMARY OF THE INVENTION

It is an object of the present invention to provide a polymer electrolyte having a new structure, which exhibits improved ionic conductivity, and a preparation method thereof.

Another object of the present invention is to provide a polymer electrolyte having a new structure, which exhibits improved ionic conductivity and mechanical properties, and a preparation method thereof.

To achieve the above objects, the present invention provides a polymer electrolyte comprising a block copolymer and an ionic liquid, the polymer electrolyte being composed of ion-conducting domains and non-conducting domains, wherein the non-conducting domains in the polymer electrolyte have defined cubic phases.

Without wishing to be bound to any particular theory, it is believed that, in the polymer electrolyte according to the present invention, particulate non-conducting domains composed of the non-conducting block of the block copolymer are dispersed in a continuous conducting matrix composed of the ionic liquid and the conducting block of the block copolymer so as to form defined cubic phases, and thus the tortuosity of ion conduction pathways is reduced to thereby improve the ionic conductivity and mechanical strength of the polymer electrolyte.

In the present invention, the cubic phases may include various cubic phases in which the tortuosity of ion conduction pathways decreases. For example, the cubic phases may include various morphologies such as simple cubic phases, body-centered cubic phases, or face-centered cubic phases. In an embodiment of the present invention, the cubic phases may include orthorhombic phases or face-centered cubic phases.

In the present invention, the size of the non-conducting domains in the polymer electrolyte having the cubic symmetry may be in the range of 1-30 nm, preferably 5-25 nm, more preferably 10-20 nm.

In the present invention, the volume of the ionic domains in the polymer electrolyte having the cubic symmetry is preferably more than 50 vol %, more preferably at least 55 vol %, even more preferably at least 60% vol %, most preferably at least 70 vol %, for example, 70-90 vol %, based on the total volume, so that the electrolyte domains may have a sufficient space for transporting ions.

In the present invention, the block copolymer is a self-assembling block copolymer, the conducting block and non-conducting block of which form self-assembled nanostructures due to thermodynamic immiscibility.

In the block copolymer according to the present invention, the conducting block may be composed of hydrophilic block and the non-conducting block may be composed of a hydrophobic block, so that the conducting and non-conducting blocks are thermodynamically immiscible.

In an embodiment of the present invention, the hydrophilic block may be a polyethylene oxide block, a poly(methylmethacrylate) block, or a sulfonated polystyrene block, and the hydrophobic block may be a polystyrene block, a polyethylene block, or a polymethylbutylene block.

In an embodiment of the present invention, each of the conducting blocks in the block copolymer preferably has a weight-average molecular weight of 10-50 kg/mol.

In a preferred embodiment of the present invention, the sulfonated polystyrene block may be represented by the following formula (1):

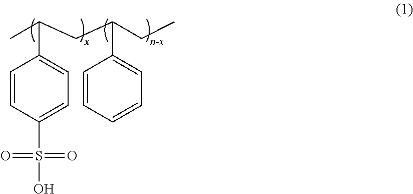

wherein n represents the degree of polymerization of styrene repeat units in the polystyrene block of the block copolymer, and is preferably 10-500, more preferably 50-200, x is an integer, and the sulfonation level represented by (x/n)*100 is 51-99.

In a preferred embodiment of the present invention, the block copolymer may be represented by the following formula (2):

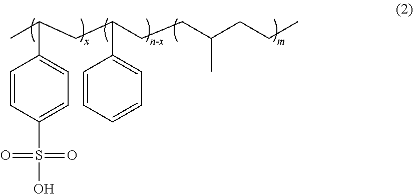

wherein n represents the degree of polymerization of styrene repeat units in the polystyrene block of the block copolymer, and is preferably an integer ranging from 10 to 500, more preferably from 50 to 200; m represents the degree of polymerization of methylbutylene, and is preferably an integer ranging from 10 to 500, more preferably from 50 to 200; and x is an integer. The sulfonation level of the styrene block is represented by (x/n)*100, and is preferably at least 30 mol % so that continuous ionic pathways can be formed in the sulfonated polystyrene block. The sulfonation level is more preferably at least 51 mol %, even more preferably at least 60 mol %, most preferably at least 70 mol %, so that the polystyrene block can show conductivity similar to that of the ionic liquid.

In the present invention, the ionic liquid comprises cations and anions.

In the present invention, the cations that are contained in the ionic liquid may be formed using one selected from among various known cationic compounds. For example, the cations may be formed using an imidazole compound, preferably an alkyl-substituted imidazole compound. Examples of the imidazole compound include imidazole, 1-methylimidazole, 2-methylimidazole, 2-ethyl-4-methylimidazole, 4-methylimidazole, 2-butyl-4-methylimidazole, 1-hexyl-3-methylimidazole, 2-undecylimidazole, 2-dodecyl-5-methylimidazole, 2-heptadecyl-4-methylimidazole, etc. Most preferably, 2-ethyl-4-methylimidazole is used.

In the present invention, the anionic compound is understood as a compound that forms an anion by ionization. The anionic compound that is used in the present invention may be a conventional anionic compound that forms the ionic liquid together with the imidazole compound. Preferably, a sulfur atom-containing anionic compound may be used. Preferred examples of the sulfur atom-containing anionic compound include CH₃SO₃⁻, CF₃SO₃⁻, (CF₃SO₂)2N⁻, (CF₃SO₂)3C⁻, N(SO₂CF₃)2⁻, etc.

In the present invention, the ionic liquid is absorbed into ionic domains such as sulfonated polystyrene to swell the ionic domains, thereby forming a dispersion medium in which nonionic domains are dispersed. Preferably, the ionic domains including the ionic liquid occupy 70-90 vol % of the total volume of the polymer electrolyte, and the remainder occupies nonionic domains. In an embodiment of the present invention, the ionic liquid preferably contains cations and anions in an amount of about 4-8 moles per mole of the sulfone group of the sulfonated polystyrene block so that the sulfone group can be sufficiently swollen.

In an embodiment of the present invention, if the ionic liquid contains cations and anions at the same mol %, the segregation strength of the nonionic domains will decrease to increase the tortuosity, even when a sufficient volume of the ionic liquid is used. For this reason, the mole fraction of the cations in the ionic liquid is preferably different from the mole fraction of the anions so as to increase the segregation strength between the ionic domains and the nonionic domains so that the nonionic domains can be located so as to form defined cubic phases. In a specific embodiment of the present invention, the mole fraction of the cations is preferably at least 55 mol %, more preferably at least 60 mol %, even more preferably at least 65 mol %, based on the total moles of the cations and the anions.

### BRIEF DESCRIPTION OF THE DRAWINGS

FIG. 1(a) shows the molecular structures of S₆₉MB₁₀₁(76), 2E4MIm, and TFSI , and FIGS. 1(b) to 1(f) show SAXS profiles of S₆₉MB₁₀₁(76) copolymers comprising 2E4MIm/TFSI⁻ at ratios of 2/1, 3/2, 4/3, 5/3, and 4/4, respectively, measured at room temperature. The dashed lines in the graphs display spherical form factor analysis.

FIGS. 2(a) and 2(b) show the through-plane conductivities of ionic liquid-containing (a) S₆₉MB₁₀₁(76) copolymers and (b) S₇₄(75) homopolymers at various compositions. Solid lines in the graphs indicate analysis using the VTF equation. FIG. 2(c) shows dissimilar tortuosities depending on the type of three-dimensional phases. Solid lines in the graph represent the best regression curves. TEM images are shown at the right.

FIGS. 3A-3D depict the distribution of grains in the surface of each of (FIG. 3A) fcc and (FIG. 3B) O⁷⁰ phases, and visualizations of the cross-sectional area of (FIG. 3C) fcc and (FIG. 3D) O⁷⁰ unit cells at grain boundaries along different planes.

FIG. 4 schematically illustrates the effects of three-dimensional morphology on the ion transport properties of ionic liquid-containing sulfonated block copolymers.

FIG. 5 illustrates a principle in which the ionic conductivity of a polymer electrolyte with cubic morphology according to the present invention increases.

FIG. 6 is a table showing the chemical properties of ionic liquids.

FIG. 7 is a table showing the mixing weight fraction (wt %) of ionic liquids at various ratios and the radius and volume fraction (vol %) of PMB spheres in ionic liquid-containing polymer electrolytes.

### DETAILED DESCRIPTION OF THE INVENTION

Hereinafter, the present invention will be described in detail with reference to examples. It is to be understood, however that these examples are for illustrative purposes only and are not intended to limit the scope of the present invention.

In the following examples, ionic liquids having various compositions were added to polymer electrolytes to form ill-defined cubic, orthorhombic O⁷⁰, and face-centered cubic (fcc) phases. The effect of each spherical lattice-based phase on ion conduction was examined.

### EXAMPLE

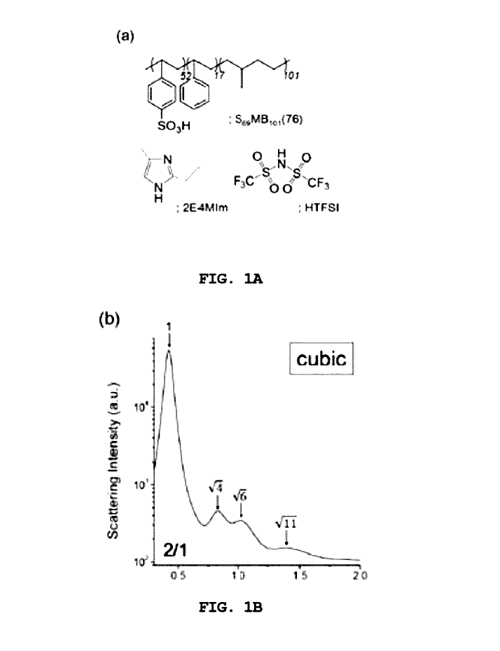

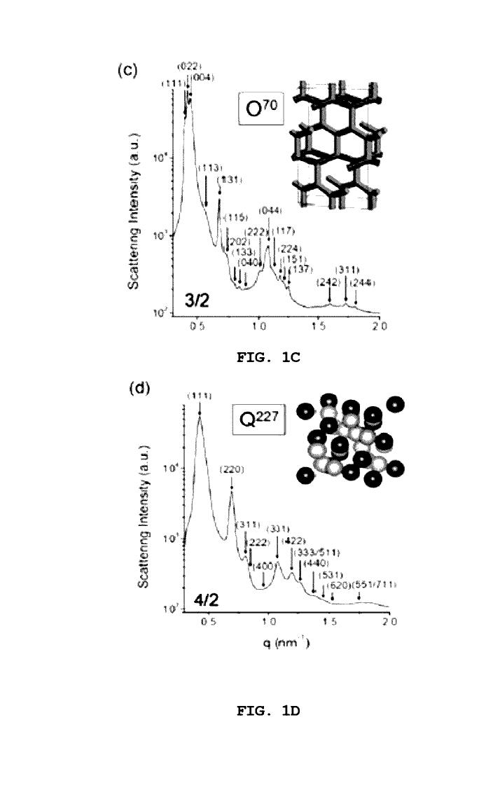

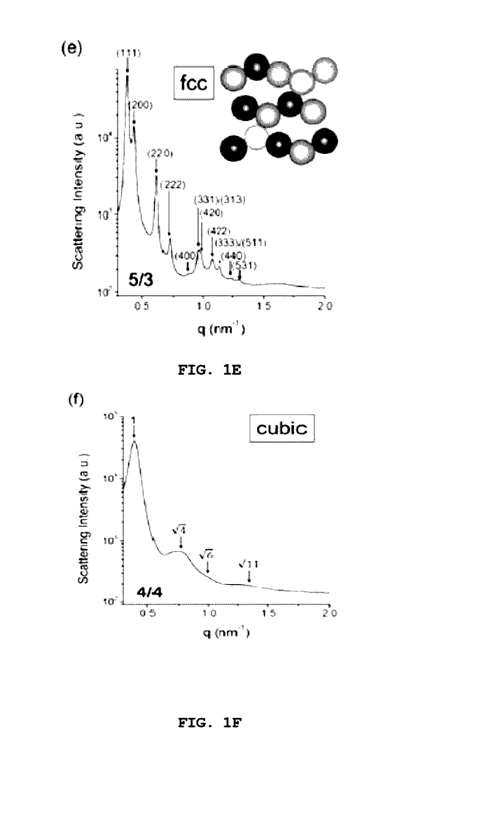

FIG. 1a shows the molecular structures of the block copolymer used and the cation and anion of the ionic liquid used. In FIG. 1a, the sulfonated block copolymer (PSS-PMB) is indicated by S₆₉MB₁₀₁(76); the subscripts indicate the degree of polymerization of each block; and the parenthesized numeral indicates the sulfonation level (SL) of the PSS block. The neat S₆₉MB₁₀₁(76) containing no ionic liquid shows hexagonally packed PBM cylinders dispersed in a PSS matrix. The ionic liquid used comprises cationic 2-ethyl-4-methylimidazole (2E4MIm) and anionic bis(trifluoromethane)sulfonamide (TFSI⁻), and the structure of each molecule is shown in FIG. 1a. The cation and the anion were incorporated into the polymer at cation/anion mole ratios of 3/2, 4/3 and 5/3. Each of the ratios was determined in proportion of the number of moles of sulfonic acid in the polymer.

### Comparative Example

This Comparative Example was carried out in the same manner as described in the Example, except that the cation/anion ratios were 2/1 and 4/4, respectively.

Comparison of Results

The morphologies of S₆₉MB₁₀₁(76) block copolymers containing ionic liquids at different compositions were investigated using small-angle X-ray scattering (SAXS) experiments. FIGS. 1b to 1f are SAXS profiles measured at room temperature, and no thermotropic phase transitions were observed in the temperature range of 25 to 180° C. As can be seen in the SAXS data of the sample comprising the polymer containing the ionic liquid at a 2E4MIm/TFSI⁻ mole ratio of 2/1 (FIG. 1b), Bragg peaks were observed at 1q*:√4q*: √6q*: √11q* with q*=2n/d and d=14.8 nm, signaling a spherical morphology in the ill-defined cubic lattices. The dashed line in the SAXS graph corresponds to a spherical form factor for R=6.25 nm:

P(q, R)=[4πR[sin(qR)−qR cos(qR)]/(qR)³]².

As can be seen in FIG. 1c, when the 2E4MIm/TFSI⁻ mole ratio was 3/2, two different peaks were observed before the first peak, and more complex Bragg peaks were developed, which can be indexed as the (111), (022), (004), (113), (131), (115), (202), (133), (040), (222), (044), planes of the orthorhombic network symmetry with space group O⁷⁰ (or Fddd).

As shown in FIG. le, when the 2E4MIm/TFSI⁻ mole ratio is changed to 4/2, 4/3, and 5/3, the samples exhibit classical signatures of an fcc phase with the Fm3̅m space group, as demonstrated by the Bragg peaks at √3q*: ρ4q*: √8q*: √11q*: 29 16q*: √19q*: √20q*: √24q*: √27q*. The domain size is d₁₁₁=16.6 nm. These results indicate that the window of fcc phases in the phase diagram is quite wide for block copolymers containing 2E4MIm/TFSI⁻. In addition, it was observed that the phase transition from O⁷⁰ to fcc phases was accompanied by the increase in the domain size from 15.8 to 16.6 nm.

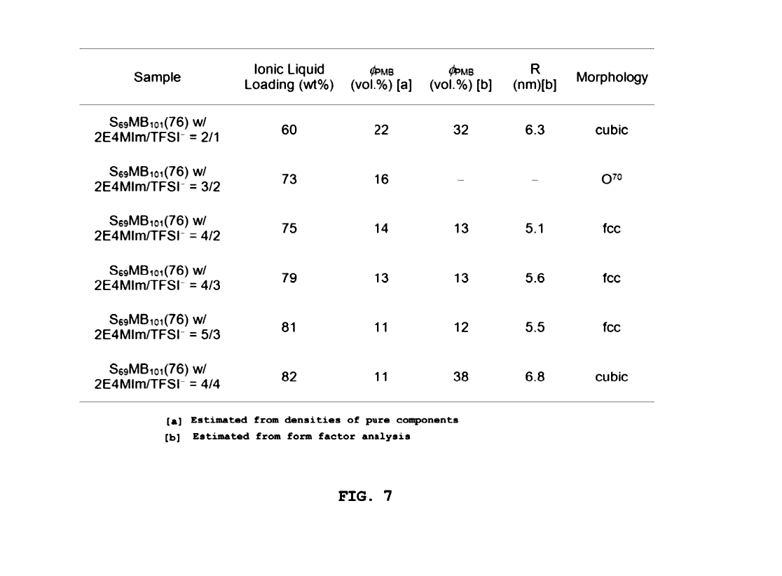

As can be seen in FIG. lf, when the 2E4MIm/TFSI mole ratio was 4/4 (the content of the ionic liquid was the highest), it was observed that the sample did not have self-assembled phases of long-range order and that the domain size of ill-defined cubic phases. This suggests that the lyotropic phase transitions in the sample passed order-disorder phase boundaries. In addition, from spherical form factor analysis, the radius of the PMB sphere was determined to be increased by >20%, compared to that of the fcc-forming samples. The results of form factor analysis of the radius of the PMB are shown in FIG. 7.

To calculate the volume fraction of PMB domains (φ)PMB) in the ionic liquid-containing block copolymers, two approaches were used. First, by using pure component densities (ρ) of ρₚₛ=1.05 g/cm³, ρ_{PSS}=1.44 g/cm³, ρ_{PMB}=0.86 g/cm³, ρ_{2E4MIm}=0.98 g/cm³, and ρ_{HTFSI}=1.94 g/cm³, the estimated volume fraction values were in the range of 11-22 vol %. Second, the φPMB values were calculated from the form factor analysis using following equation:

φ_{PMB}×α³=N×4/3/πR³

wherein N is the number of spheres in a unit cell, R is the radius of the PMB sphere, and a is the lattice parameter of the unit cell. This yields φPMB values in the range between 12 and 38 vol %, as summarized in FIG. 7. For fcc phases, the φPMB values estimated from the form factor analysis were similar to those based on density calculation.

Assuming that changing the 2E4MIm/TFSI⁻ composition from 2/1 to 3/2, 4/2, 4/3, 5/3, and 4/4 corresponds to a simple increase in the ionic liquid concentration, the PSS blocks are expected to be increasingly swollen and the interfacial curvature is gradually driven toward the ionophobic PMB domains. In this case, the projected phases follow a horizontal path across the conventional phase diagrams of nonionic block copolymers toward increasing PSS block volume fraction, which is, in part, consistent with the above-described observation. However, because spherical lattices other than bcc phases are known to occupy a very narrow window of the phase diagram, it is inferred that the addition of ionic liquids to an ionic block copolymer greatly expanded the range of accessible self-assembled morphology by modifying the balance of interfacial area and chain stretching.

The modification of ionic interactions by varying the ratio of cations and anions in ionic liquids may be a cause of altering the selectivity of ionic liquids to the PSS phases. For example, a 4/2 2E4Mm/TFSI⁻ system is more selective for the PSS block than a 3/2 2E4Mm/TFSI system. This finding is analogous to the results of nonionic block copolymer/selective solvent systems, as pioneered by Lodge et al. Namely, the segregation strength between ionic liquid-embedded PSS phases and PMB domains could be changed by ionic interactions modified by varying the ratio of cations and anions. The decrease in segregation strength in ionic liquid-containing strength in PSS-PMB block copolymers is inferred when the composition (cation/anion ratio) is closer to the equivalence (1/1), as seen from the smallest swelling of PSS phases (1-φMB) with a 4/4 2E4Mm/TFSI⁻ system.

The gyroid structure was not observed in the system of the present invention. However, in previous studies conducted by the present inventors, O²³⁰ phases could be observed in the S₃₀MB⁴⁴(17) copolymer with a low molecular weight and a low SL, i.e., weaker segregation (low XN, where X is the Flory-Huggins interaction parameter and N is the degree of polymerization), when a 2/1 2E4MIm/TFSI⁻ system was added. This implies that fcc phases and orthorhombic O⁷⁰ are observed in a system with high segregation strength (XN) and low PMB volume fraction and that O²³⁰ is observed as XN decreases.

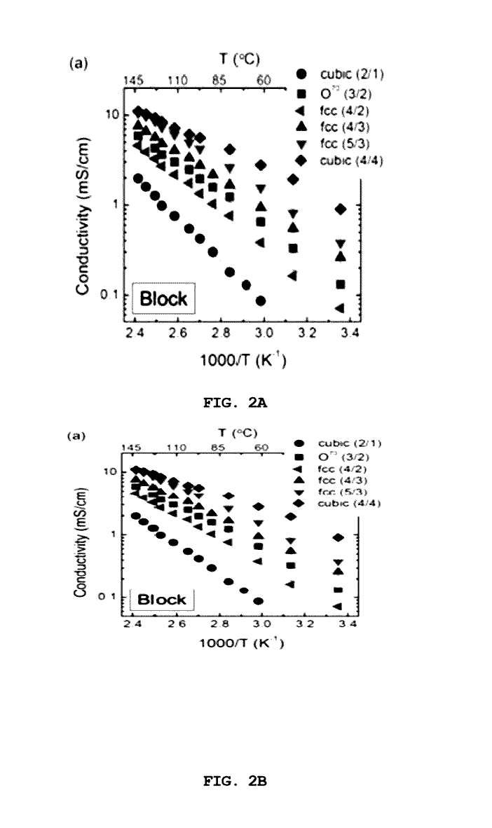

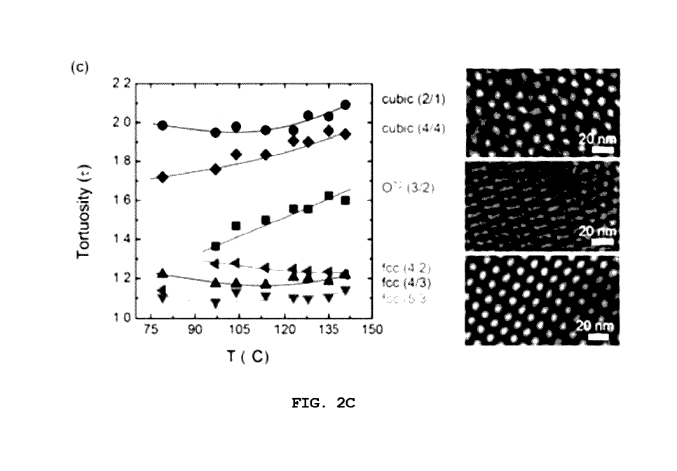

In order to unveil the ideal morphology with less tortuous ion-conduction pathways for the structures of the present invention, the ionic conductivity of each polymer electrolyte was measured. FIG. 2a shows the ionic conductivity of polymer electrolytes comprising S₆₉MB₁₀₁(₇₆) combined with 2E4MIm/TFSI systems for various compositions in the temperature range of 25 to 150° C. As controls, the results of ionic liquid-containing PSS homopolymers are also shown in FIG. 2b wherein a PSS homopolymer with N=74 and SL=75 mol % (hereinafter referred to as S₇₄(75)) was employed.

The ionic conductivity of ionic liquid/polymer composites appears to be closely related to the intrinsic transport properties of neat ionic liquids. In other words, a polymer electrolyte with 2E4MIm/TFSI⁻=4/4 shows the highest ionic conductivity, whereas a polymer electrolyte with 2E4MIm/TFSI⁻=4/2 shows the lowest ionic conductivity, in qualitative agreement with the conductivity of neat ionic liquids.

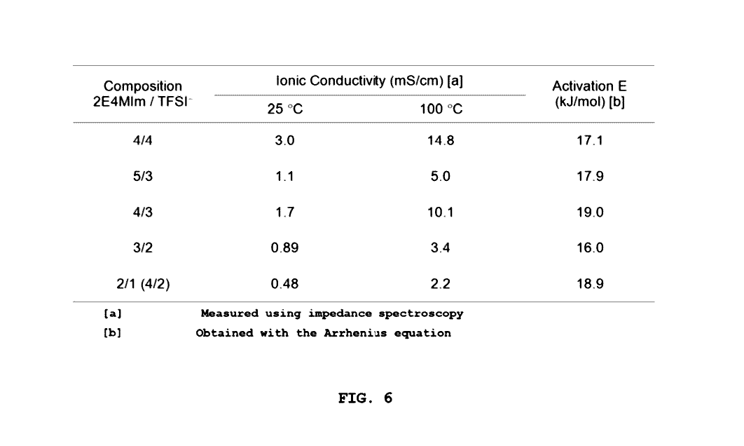

The conductivities of neat ionic liquids are summarized in FIG. 6. As can be seen therein, the opposite trend in conductivity between ionic liquids and ionic liquid/polymer composites was seen with the 5/3 and 4/3 2E4MIm/TFSI⁻ compositions. This indicates that the ion transport properties of ionic liquids can be significantly altered if they are embedded in polymers because of the existence of ionic interactions between polymer matrices and combined ionic liquids. A large reduction in conductivity for the 2/1 2E4MIm/TFSI⁻ samples is attributed to the low ion concentration in the polymer membranes.

To underpin the effects of the three-dimensional symmetry on the ionic conductivity of ionic liquid/polymer electrolytes, the tortuosity (i) for ion conduction pathways was calculated. The ionic conductivity of the block copolymer system can be expressed by the following equation:

$$σ = \frac{{φσ}_{max}}{τ}$$

wherein σ represents the ionic conductivity of the block copolymer, σₘₐₓ represents the ionic conductivity of ionic domains (homopolymer S₇₄(75)), and φ represents the volume fraction of ionic domains in the block copolymer.

FIG. 2c is a graph showing the tortuosity (τ) values in ion conduction pathways, obtained by calculation using the above equation. As can be seen therein, the tortuosity (τ) values vary depending on different phases. The samples containing 2/1 and 4/4 2E4MIm/TFSI⁻ systems (i.e., ill-defined cubic lattices) exhibited the highest tortuosity (1.93±0.17), indicating that dead ends unnecessary for ion conduction are considerably present at grain boundaries, making ion conduction inefficient. The tortuosity (τ) value of O₇₀ phases at a 3/2 2E4MIm/TFSI ratio is approximately 1.52±0.12, and this slightly low tortuosity (τ) value is because the O₇₀ phases are ionic domains connected to one another by orthorhombic lattices.

The samples with fcc phases of 4/2, 4/3, and 5/3 2E4MIm/TFSI⁻ showed the lowest tortuosity (τ) values approaching 1 (1.17±0.08). This suggests that well-defined spherical morphologies based on face-centered cubic symmetry with majority ionic phases may be important to the improvement of ion transport properties of polymer electrolyte membranes.

Given that the tortuosity quantified the topological parameters of the conducting phases, possible explanations for the different tortuosities for the O⁷⁰ and fcc phases despite the similar volume fractions of the conducting phases (O⁷-84 and fcc-87%) include the different grain sizes and dissimilar cross-sectional areas of the conducting pathways at grain boundaries.

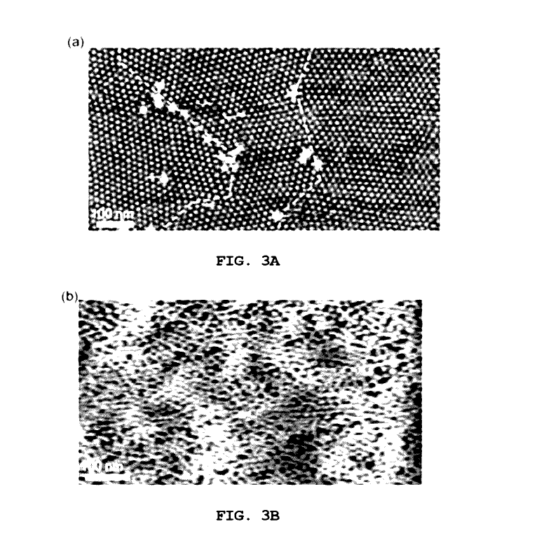

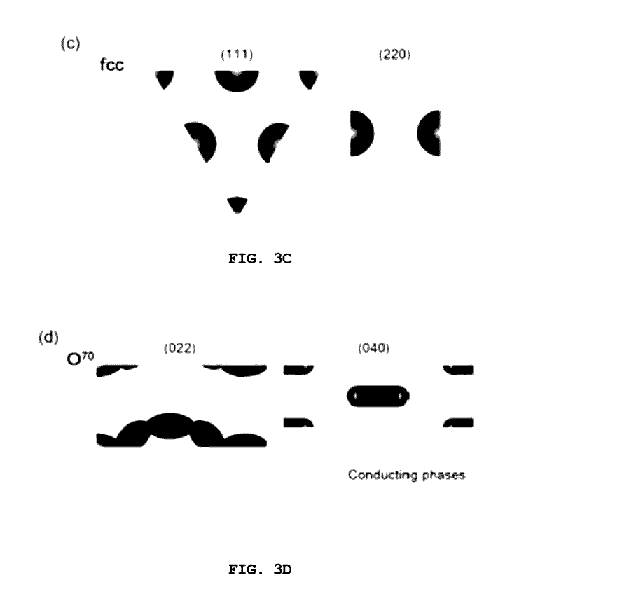

FIGS. 3a and 3b show surface morphologies measured by scanning probe microscopy (SPM). Experiments were performed by preparing thin films using S₆₉MB₁₀₁(76) polymers containing 2E4MIm/TFSI⁻=5/3 and 2E4MIm/TFSI⁻=3/2 as ionic liquids. FIG. 3a shows grains in fcc phases, and as can be seen therein, the defect density was low, and thus the grain size was large. On the other hand, as can be seen in FIG. 3b, the O⁷⁰ phases were found out to be defective, which should be responsible for the increased tortuosity (τ) values rather than the theoretical value of 1.

In addition, FIGS. 3c and 3d show visualizations of the cross-sectional areas of fcc and O⁷⁰ unit cells, respectively, at representative grain boundaries. As can be seen therein, the conducting phases occupy 76 and 85% of the cross-sectional area for the fcc phases at planes of (111) and (220), respectively. In contrast, the areas were as small as 70% and 74% for the O⁷⁰ phases at the (022) and (040) planes, respectively, which are smaller than those for the fcc phases.

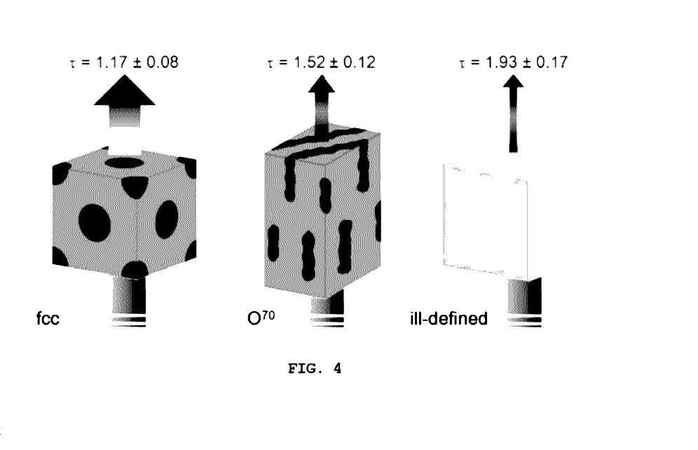

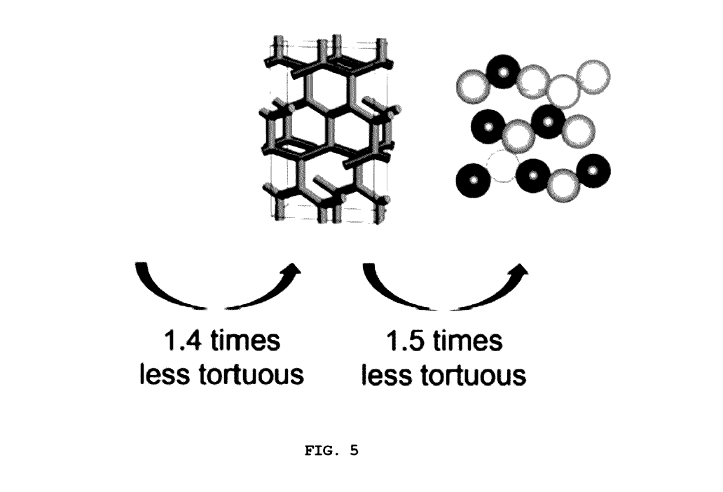

On the basis of the results obtained thus far, the schematic illustration of dissimilar ion transport efficiencies of ionic liquid-containing block copolymers, depending on the three-dimensional order, is shown in FIG. 4. In the present invention, a polymer electrolyte based on conducting PSS domains was developed, and it was found that cubic fcc phases have less tortuous ion-conduction pathways compared to O⁷⁰ phases, and thus exhibit improved ion conduction properties.

In summary, the present inventors have presented the first experimental data indicating that the three-dimensional cubic morphology according to the present invention creates less tortuous ion-conduction pathways. Furthermore, the present inventors have developed polymer electrolytes based on conducting phases by incorporating ionic liquids containing cations and anions at different fractions into block copolymers.

In conclusion, the addition of a 3/2 2E4MIm/TFSI⁻ system into the PSS-PMB copolymer resulted in the development of O⁷⁰ phases with orthorhombic symmetry, whereas with 4/2, 4/3, and 5/3 2E4MIm/TFSI⁻ compositions, well-defined fcc phases with cubic symmetry were formed. The structural optimization of ionic liquid-containing polymer electrolyte systems was crucial for attaining desired ion transport properties. It was found that polymer electrolytes with cubic fcc phases based on conducting phases exhibit efficient ion transport properties compared to electrolytes having orthorhombic O⁷⁰ network phases.

In the present invention, the tortuosity of each morphological phase was calculated, and the cross-sectional areas of ion conducting pathways at various grain boundaries were also examined. Namely, studies on polymer electrolytes that exhibit improved ion conduction properties due to formation of such cubic phases will provide a change to expand their applicability to various electrochemical devices (fuel cells, lithium ion batteries, storage batteries, electro-active actuators, etc.).

Synthesis of PSS-b-PMB Copolymer

A poly(styrene-b-methylbutylene) (PS-b-PMB) block copolymer (7.1-7.1 kg/mol) was synthesized by sequential anionic polymerization of styrene and isoprene and subsequent hydrogenation of the polyisoprene. The polydispersity index of the hydrogenated polymer was 1.03, and the molecular weight and molecular weight distribution of the PS-b-PMB copolymer were characterized by ¹H nuclear magnetic resonance (¹H NMR, Bruker AVB-300) spectroscopy and gel permeation chromatography (GPC, Waters Breeze 2 HPLC). Then, the PS block of the PS-b-PMB copolymer was sulfonated. A sulfonation level of 76 mol % was determined by the ratio of the total number of moles of sulfonated styrene (after sulfonation) to the total number of moles of styrene (before sulfonation).

Ionic liquids (ILs)

2-ethyl-4-methylimidazole ([2E4MIm], 95.0%), and bis(trifluoromethane)sulfonimide ([HTFSI], 95%) were purchased from Sigma Aldrich. A set of nonstoichiometric ionic liquids was synthesized by mixing cationic 2E4MIm and anionic HTFSI in different molar ratios, followed by heating above the melting temperature of the ionic liquid. The final compositions of the synthesized nonstoichiometric ionic liquids were determined by Fourier transform infrared (FT-IR) spectroscopy experiments.

Preparation of Ionic Liquid-Containing PSS-PMB Membranes

Inhibitor-free anhydrous tetrahydrofuran (THF, ≧99.9%) was used without further purification, and methanol was degassed twice before being used. Predetermined amounts of ionic liquids based on 2E4MIm and HTFSI were integrated into the PSS-PMB copolymer at 2E4MIm/HTFSI ratios of 5/3, 4/4, 4/3, 4/2, 3/2, and 2/1 with respect to the moles of —SO₃H in the polymer. Then, 5 wt % solutions of the mixtures were prepared using 50/50 vol % THF and methanol mixtures as solvents. The prepared solutions were stirred overnight at room temperature. Membranes were prepared by solvent casting under an Ar atmosphere for 2 days followed by vacuum drying at 70° C. for 7 days. To exclude the issue of water contamination of the hygroscopic samples, the sample preparations and measurements were performed under an Ar-filled glovebox with a moisture concentration of <0.1 ppm.

Small Angle X-ray Scattering (SAXS).

Synchrotron SAXS measurements of the ionic liquid-containing PSS-PMB membranes were performed using the PLS-II 4C SAXS beamline at the Pohang Accelerator Laboratory (PAL). The samples were laminated into an airtight cell (composed of aluminum spacers, two sheets of Kapton window, O-rings, and an aluminum cover), and the sample temperature was controlled within ±0.2° C. using a sample stage provided by the PLS. The wavelength (λ) of the incident X-ray beam was 0.15 nm (Δλ/λ=10⁻⁴), and sample-to-detector distances of 1.5 m and 0.5 m were used. The resulting two-dimensional scattering data were averaged azimuthally to obtain intensity versus scattering wave vector q [q=4n sin(θ/2)/λ, where θ is the scattering angle].

Conductivity Measurements

The conductivities of ionic liquid-containing PSS-PMB membranes were measured by AC impedance spectroscopy in a glovebox. The through-plane conductivity was measured using a home-built two-electrode cell with 1.25 cm×1.25 cm stainless steel blocking electrodes, Kapton spacers, and 1 cm×1 cm platinum working plates. Specifically, a blocking electrode with a 0.8 cm×0.8 cm hole was prepared, and the sample (0.8 cm×0.8 cm×200 μm) was loaded in the hole. A Kapton spacer having a predetermined hole size was attached to the upper and lower sides of the blocking electrode which was then sandwiched between two platinum plates, and current was applied thereto to measure the conductivity of the sample. Herein, the platinum plates serve as working and counter electrodes. Data were recorded by the 1260 Solatron impedance analyzer operating in a frequency range of 10-100000 Hz.

As described above, the present invention provides a novel ion-conducting polymer electrolyte having cubic symmetry. The ion-conducting polymer electrolyte with cubic symmetry according to the present invention is highly permeable to ions due to its low tortuosity, and thus exhibits high ion conductivity. In addition, it has a well-defined cubic symmetry, and thus exhibits excellent mechanical strength.

1. A polymer electrolyte, comprising a block copolymer and an ionic liquid, the polymer electrolyte being composed of ion-conducting domains and non-conducting domains, wherein the non-conducting domains are dispersed in the ion-conducting domains to form defined cubic phases.

2. The polymer electrolyte of claim 1, wherein the cubic phases are orthorhombic phases or face-centered cubic phases.

3. The polymer electrolyte of claim 1, wherein the non-conducting domains have a size of 1-30 nm.

4. The polymer electrolyte of claim 1, wherein the volume of the ion-conducting domains is at least 55 vol % based on the total volume of the ion-conducting domains and the non-conducting domains.

5. The polymer electrolyte of claim 4, wherein the volume of the ion-conducting domains is 70-90 vol % based on the total volume of the ion-conducting domains and the non-conducting domains.

6. The polymer electrolyte of claim 1, wherein the ion-conducting domains are composed of the ionic liquid and an ion-conducting block of the block copolymer, and the non-conducting domains are composed of a non-ion-conducting block of the block copolymer.

7. The polymer electrolyte of claim 1, wherein the block copolymer is composed of a sulfonated polystyrene block and a non-ion-conducting block.

8. The polymer electrolyte of claim 7, wherein the sulfonated polystyrene block is represented by the following formula (1): 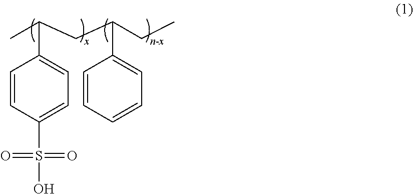
wherein n represents the degree of polymerization of styrene repeat units in the polystyrene block of the block copolymer, and is 10-500; x is an integer; and a sulfonation level represented by (x/n)* 100 is 60-90.

8. The polymer electrolyte of claim 1, wherein the block copolymer is represented by the following formula (2): 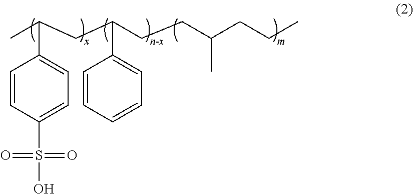
wherein n represents the degree of polymerization of styrene repeat units in the polystyrene block of the block copolymer, and is 10-500; m represents the degree of polymerization of methylbutylene, and is 10-500; x is an integer; and a sulfonation level represented by (x/n)* 100 is 70-90 mol %.

10. The polymer electrolyte of claim 1, wherein the ionic liquid contains cations in an amount of at least 55 mol % based on the total moles of the cations and anions.

11. The polymer electrolyte of claim 1, wherein the ionic liquid contains cations in an amount of at least 65 mol % based on the total moles of the cations and anions.

12. The polymer electrolyte of claim 7, wherein the ionic liquid contains cations and anions in an amount of 4-8 moles per mole of a sulfone group of the sulfonated polystyrene block.

13. The polymer electrolyte of claim 1, wherein the ionic liquid is composed of: at least one cationic compound selected from the group consisting of imidazole, 1-methylimidazole, 2-methylimidazole, 2-ethyl-4-methylimidazole, 4-methylimidazole, 2-butyl-4-methylimidazole, 1-hexyl-3-methylimidazole, 2-undecylimidazole, 2-dodecyl-5-methylimidazole, and 2-heptadecyl-4-methylimidazole; and a sulfur atom-containing anionic compound.

14. A method for preparation of a polymer electrolyte comprising a block copolymer and an ionic liquid, the polymer electrolyte being composed of ion-conducting domains and non-conducting domain, the method comprising dispersing the non-conducting domains to form defined cubic phases.

15. A secondary battery comprising a polymer electrolyte according to claim 1.
